(19) United States
(12) Patent Application Publication
(10) Pub. No.: US 2014/0273956 A1
(43) Pub. Date: Sep. 18, 2014

(54) MOTION INITIATED TELECONFERENCE

(71) Applicants: Jim S. Baca, Corrales, NM (US); David Stanasolovich, Albuquerque, NM (US); Mark H. Price, Placitas, NM (US); Joshua Boelter, Portland, OR (US)

(72) Inventors: Jim S. Baca, Corrales, NM (US); David Stanasolovich, Albuquerque, NM (US); Mark H. Price, Placitas, NM (US); Joshua Boelter, Portland, OR (US)

(21) Appl. No.: 13/832,870

(22) Filed: Mar. 15, 2013

(51) Int. Cl. H04W 76/02; H04W 4/16; H04W 64/00; H04W 12/08

(52) U.S. Cl. CPC H04W 76/025; H04W 12/08; H04W 4/16; H04W 64/006
USPC 455/411

(57) ABSTRACT

Systems and method may provide for a communication device that includes a primary communications module, a sensor, and a secondary wireless communications module. The sensor may detect a motion towards a second device while the communication device is involved in a real-time communication with one or more parties using the primary communications module. The secondary wireless communications module may invite the second device to join the real-time communication if the second device is authorized to take part in the real-time communication.

### BACKGROUND

Currently, it may be difficult to add a person to a real-time communication using a mobile device without making arrangements to do so ahead of time. For example, if a person receives a phone call on a cellular smart phone while traveling, it is difficult to add a second person to the call who may be standing nearby.

In other words, although a user may be able to set up a bridge meeting, send meeting invites to others with a link to a Live Meeting session, and/or the like, it may be difficult to do so when the user is mobile.

### BRIEF DESCRIPTION OF THE DRAWINGS

The various advantages of the embodiments will become apparent to one skilled in the art by reading the following specification and appended claims, and by referencing the following drawings, in which:

FIG. 1A is an example illustration showing a person communicating with two other people;

FIG. 1B is an example illustration showing a person adding another person to an existing communication an aspect of an embodiment;

FIG. 2 is an example block diagram of a system according to aspects of some of the various embodiments.

FIG. 3 is an example flow diagram of an example of a method of a person adding another person to an existing communication according to an embodiment;

FIG. 4 is a block diagram of an example of a processor according to an aspect of an embodiment; and

FIG. 5 is a block diagram of an example of a system according to an aspect of an embodiment.

### DETAILED DESCRIPTION

Embodiments may enable a first mobile device to use a physical motion to add a second device to a real-time communication. This motion may be referred to a “fling.” So for example, some of the various embodiments described herein provide a mechanism that allows currently engaged phone calls to be “flung” from one known Smartphone to another known wireless phone (e.g., smart phone). Similarly, some of the various embodiments provide a capability for a user to “fling” other types of communications such as Live Meetings, Lync sessions, and/or the like between known devices.

FIG. 1A is a block diagram showing a person 110 (e.g., user, individual) communicating with two other people 120 and 130 in a conference call. In the illustrated example, person 110 is using mobile device 115, person 120 is using device 125 and person 130 is using device 135 to complete the call over a communications network 250. Person 140 may be standing close to person 110, but not part of the conference call. FIG. 1B is block diagram showing person 110 adding person 140 to the existing conference call by moving mobile 115 device in the direction of person 140. In this manner, it is possible for a person to add another person to a conversation without having to reinitiate a conference call from scratch. Additionally, it may be possible to add the additional person without having to vocally interrupt the current conversation.

FIG. 2 is a block diagram of a system according to aspects of some of the various embodiments. This example diagram shows a first device 210 communicating with a second device 220 through communication network 250 using a primary communications channel. As will be explained, the device 230 may join the communication between devices 210 and 220 in response to a communication 203 over a secondary communications channel.

Device 210 may include a primary communications module, a sensor, and a secondary communications module.

The primary communications module 211 may be a transceiver capable of supporting bi-directional real-time communications, wherein a transceiver is a device comprising both a transmitter and a receiver. Examples of transceivers include cellular transceivers configured to support cellular phone communications, Wi-Fi configured to support wide area network communications, and/or the like.

According to some of the various embodiments, the sensor 213 may be a detection device configured to detect a motion towards another device (e.g. device 230) while device 210 is involved in a real-time communication with one or more parties (e.g. device 220 employing primary communications module 221) using the primary communications module 211. The sensor 213 may include a detector such as: an accelerometer, a global positioning system, a camera, an IR sensor, a gyroscope, a combination of the thereof, and/or the like. The sensor 213 may process the detector signals to determine the direction and strength of the motion. Alternatively, a device external to the sensor 213 may process the sensor 213 output to determine the direction and strength of the motion.

The secondary communications module 212 may be employed to invite the other device 230 (employing secondary communications module 232) to join the real-time communication the primary communications module 231 of the device 230. The secondary communications module 212 may be a wireless communications module. The real-time communication may include one or more of: a cellular phone call; an Internet phone call, an audio stream, a video stream, and/or the like. The real-time communication may be hosted through a service provider or may be a direct communication. The secondary communications module 212 may employ one or more of the following communications technologies: Wi-Fi technology, near field communications technology (NFC); Bluetooth technology, and/or the like.

According to some of the various embodiments, the second device 230 may need to be authorized to take part in the real-time communication. Depending upon the specific embodiment, the authorization may implicit or explicit. Implicit authorization may be determined by the mere motion of the first device 210 to a second device 230. Explicit authorization may be based upon a device 230 being a member of a secure circle 256 of devices that are authorized to communicate. Additionally, authorization may be based upon other factors such as an authorization rule, a list, a characteristic of the device(s), and/or the like. Authorization may be performed by an authorization module 214. The authorization module 214 may be configured to determine whether the device 230 is part of a secure circle 256, and/or satisfies some other authorization factor.

According to some of the various embodiments, device 210 may further include a request module 215 configured to request a primary communications provider to add the device to the real-time communication. For example, if the primary communications are via a cellular service, the request module 215 could be configured to make requests to the cellular service provider to add device 230 to the real-time communication.

Device 210 may operate using processing hardware, non-processing hardware, and/or a combination of processing hardware and non-processing hardware. Processing hardware may employ one or more processors 254 to execute instructions 256 stored on memory 256.

FIG. 3 is a flow diagram of actions as per aspects of some of the various embodiments. At block 310, a first device may detect, by a sensor, a motion towards a second device while the first device is involved in a real-time communication with one or more parties. The first device and/or the second device may be a device such as a mobile device such as a cellular phone, a smart phone, a tablet, and/or the like. The sensor may include a motion detection device such as: an accelerometer, a global positioning system, camera, an IR sensor, a gyroscope, and/or the like. The real-time communication may include a communication such as: a cellular phone call, an Internet phone call, an audio stream, a video stream, and/or the like.

The first device may communicate with the second device using a secondary communications technology at block 320. The secondary communications module may be a wireless communications module. Examples of secondary communications technologies include: Wi-Fi technology, near field communications technology, Bluetooth technology, and/or the like.

The first device may determine if the second device is authorized to take part in the real-time communication at block 340. Some of the various embodiments may make this determination by determining if the second device is part of a secure circle at block 330. A secure circle may be a list of users and devices authorized to communicate with the first device. Those skilled in the art will recognize that other techniques may be employed to determine if the second device is authorized to communicate with the first device such as following a rule. A rule may be temporal or location based. For example, a rule may state that no calls may be joined in a conference room at work, or no call may be joined in a moving automobile. Another example rule may be that any call may be joined. If the determination is negative, the actions may stop at block 380. This security capability may allow a second device to enter into a secure circle with other identified/known devices where certain credentials are shared enabling them to “know” each other and share certain resources between them.

The first device may invite the second device to join the real-time communication at block 350. According to some of the various embodiments, the invitation may take place over the secondary communications technology.

A determination of whether the second device has accepted the invitation may be made at block 360. Again, if the determination is negative, the actions may stop at block 380. If the determination is positive, the first device may request a cellular service provider to add the second device to the real-time communication at 370.

According to some of the various embodiments, the devices and actions described above may be employed as a platform for devices such as wireless phone (e.g., smartphone) based devices to allow the user to share phone calls with other known smartphone devices that are within a close proximity of one another. The devices may include each other in an elevated security circle where they recognize each other via wireless technology (e.g. Bluetooth, NFC tap in, Wi-Fi, and/or the like) and may share info with one another. The smartphone devices may employ a motion sensing device (such as an accelerometer, gyroscope, and/or the like) to detect motion of the device, allowing the user to fling his smartphone device in the direction of a known other receiving smartphone device to invite the receiving smartphone to join a preexisting phone call.

According to some of the various embodiments, software in combination with hardware may run on devices such as smartphones that enables the “fling” capability for calls. When invoked, the software in combination with hardware may capture device motion information from on-device sensors such as accelerometers, gyroscopes, and/or the like to enable the “fling” (quick motion of device) to establish communications with another known device in the vicinity. This software in combination with hardware may also contact the cellular service provider and inform them that the currently engaged in call needs to be shared with the phone number of the designated receiving known device. The service provider may call the designated device and provide the user of that device the option to answer and be included in the call with the other parties.

FIG. 4 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 4, a processing element may alternatively include more than one of the processor core 400 illustrated in FIG. 4. The processor core 400 may be a single-threaded core or, for at least one embodiment, the processor core 400 may be multithreaded in that it may include more than one hardware thread context (or “logical processor”) per core.

FIG. 4 also illustrates a memory 470 coupled to the processor 400. The memory 470 may be any of a wide variety of memories (including various layers of memory hierarchy) as are known or otherwise available to those of skill in the art. The memory 470 may include one or more code 413 instruction(s) to be executed by the processor 400 core, wherein the code 413 may implement the logic architecture illustrated in FIG. 3, already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end 410 also includes register renaming logic 425 and scheduling logic 430, which generally allocate resources and queue the operation corresponding to the convert instruction for execution.

The processor 400 is shown including execution logic 450 having a set of execution units 455-1 through 455-N. Some embodiments may include a number of execution units dedicated to specific functions or sets of functions. Other embodiments may include only one execution unit or one execution unit that may perform a particular function. The illustrated execution logic 450 performs the operations specified by code instructions.

After completion of execution of the operations specified by the code instructions, back end logic 460 retires the instructions of the code 413. In one embodiment, the processor 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 4, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

Referring now to FIG. 5, shown is a block diagram of a system embodiment 500 in accordance with an embodiment. Shown in FIG. 5 is a multiprocessor system 500 that includes a first processing element 570 and a second processing element 580. While two processing elements 570 and 580 are shown, it is to be understood that an embodiment of system 500 may also include only one such processing element.

System 500 is illustrated as a point-to-point interconnect system, wherein the first processing element 570 and second processing element 580 are coupled via a point-to-point interconnect 550. It should be understood that any or all of the interconnects illustrated in FIG. 5 may be implemented as a multi-drop bus rather than point-to-point interconnect.

As shown in FIG. 5, each of processing elements 570 and 580 may be multicore processors, including first and second processor cores (i.e., processor cores 574a and 574b and processor cores 584a and 584b). Such cores 574, 574b, 584a, 584b may be configured to execute instruction code in a manner similar to that discussed above in connection with FIG. 5.

Each processing element 570, 580 may include at least one shared cache 560. The shared cache 560a, 560b may store data (e.g., instructions) that are utilized by one or more components of the processor, such as the cores 574a, 574b and 584a, 584b, respectively. For example, the shared cache may locally cache data stored in a memory 532, 534 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 570, 580, it is to be understood that the scope of the embodiments is not so limited. In other embodiments, one or more additional processing elements may be present in a given processor. Alternatively, one or more of processing elements 570, 580 may be an element other than a processor, such as an accelerator or a field programmable gate array. For example, additional processing element(s) may include additional processors(s) that are the same as a first processor 570, additional processor(s) that are heterogeneous or asymmetric to processor a first processor 570, accelerators (such as, e.g., graphics accelerators or digital signal processing (DSP) units), field programmable gate arrays, or any other processing element. There may be a variety of differences between the processing elements 570, 580 in terms of a spectrum of metrics of merit including architectural, microarchitectural, thermal, power consumption characteristics, and the like. These differences may effectively manifest themselves as asymmetry and heterogeneity amongst the processing elements 570, 580. For at least one embodiment, the various processing elements 570, 580 may reside in the same die package.

First processing element 570 may further include memory controller logic (MC) 572 and point-to-point (P-P) interfaces 576 and 578. Similarly, second processing element 580 may include a MC 582 and P-P interfaces 586 and 588. As shown in FIG. 8, MC's 572 and 582 couple the processors to respective memories, namely a memory 532 and a memory 534, which may be portions of main memory locally attached to the respective processors. While the MC logic 572 and 582 is illustrated as integrated into the processing elements 570, 580, for alternative embodiments the MC logic may be discrete logic outside the processing elements 570, 580 rather than integrated therein.

The first processing element 570 and the second processing element 580 may be coupled to an I/O subsystem 550 via P-P interconnects 576, 586 and 584, respectively. As shown in FIG. 5, the I/O subsystem 550 includes P-P interfaces 554 and 558. Furthermore, I/O subsystem 550 includes an interface 552 to couple I/O subsystem 550 with a high performance graphics engine 538. In one embodiment, bus 545 may be used to couple graphics engine 538 to I/O subsystem 550. Alternately, a point-to-point interconnect 535 may couple these components.

In turn, I/O subsystem 550 may be coupled to a first bus 516 via an interface 556. In one embodiment, the first bus 516 may be a Peripheral Component Interconnect (PCI) bus, or a bus such as a PCI Express bus or another third generation I/O interconnect bus, although the scope of the embodiments is not so limited.

As shown in FIG. 5, various I/O devices 514 such as sensor(s) may be coupled to the first bus 516, along with a bus bridge 518 which may couple the first bus 516 to a second bus 510. In one embodiment, the second bus 520 may be a low pin count (LPC) bus. Various devices may be coupled to the second bus 520 including, for example, a keyboard/mouse 512, communication device(s) 526 (which may in turn be in communication with a computer network), and a data storage unit 540 such as a disk drive or other mass storage device which may include code 530, in one embodiment. The code 530 may include instructions for performing embodiments of one or more of the methods described above. Thus, the illustrated code 530 may implement the logic architecture illustrated in FIG. 3 and could be similar to the code 513 (FIG. 6), already discussed. Further, an audio I/O 524 may be coupled to second bus 520.

Note that other embodiments are contemplated. For example, instead of the point-to-point architecture of FIG. 5, a system may implement a multi-drop bus or another such communication topology. Also, the elements of FIG. 5 may alternatively be partitioned using more or fewer integrated chips than shown in FIG. 5.

### Additional Notes and Examples

Examples may include an apparatus to facilitate communications, wherein the apparatus comprises a primary communications module, a sensor, and a secondary communications module. The sensor may detect a motion towards a device while the primary communications module is involved in a real-time communication with one or more parties. The secondary communications module may be a wireless communications module. The secondary communications module may invite the second device to join the real-time communication if the device is authorized to take part in the real-time communication. The sensor may include one or more of: an accelerometer; a global positioning system; a camera; an infrared sensor; and a gyroscope. The primary communications module may include a cellular transceiver. The apparatus may further include an authorization module to determine whether the device is part of a secure circle. The real-time communication may include one or more of: a cellular phone call; an Internet phone call; and an audio stream; and a video stream. The secondary communications module may include one or more of: Wi-Fi technology; near field communications technology; and Bluetooth technology. The apparatus may further include a request module to request a cellular service provider to add the device to the real-time communication.

Examples may include a method to facilitate communications. The method may include detecting, by a sensor, a motion on a first device towards a second device while the first device is involved in a real-time communication with one or more parties. The method may further include inviting the second device to join the real-time communication if the second device is authorized to take part in the real-time communication. The motion on the first device may be detected by one or more of: an accelerometer; a global positioning system; a camera; an infrared sensor; and a gyroscope. One of a cellular phone, a smart phone, and a tablet may be used to make the motion. One or more of a cellular phone, a smart phone and a tablet may be invited to join the real-time communication. The method may further include determining whether the second device is part of a secure circle. The real-time communication may include one or more of the following: a cellular phone call; an Internet phone call; an audio stream; and a video stream. The method may further include communicating with the second device using a secondary communications technology. The secondary communications technology may include one or more of: Wi-Fi technology; near field communications technology; and Bluetooth technology. The method may further include requesting a cellular service provider to add the second device to the real-time communication.

Examples may include at least one non-transitory machine-readable medium comprising one or more instructions which, if executed by a processor, may cause a first device to detect, by a sensor, a motion towards a second device while the first device is involved in a real-time communication with one or more parties. The one or more instructions which, if executed by a processor, may also invite the second device to join the real-time communication if the second device is authorized to take part in the real-time communication. The motion on the first device may be detected by one or more of: an accelerometer; a global positioning system; a camera; an infrared sensor; and a gyroscope. One of a cellular phone, a smart phone, and a tablet may be used to make the motion. One or more of a cellular phone, a smart phone and a tablet may be invited to join the real-time communication. The one or more instructions which, if executed by a processor, may further cause the first device to determine whether the second device is part of a secure circle. The real-time communication may include at least one of the following: cellular phone call; an Internet phone call; an audio stream; and a video stream. The instructions, if executed, may further cause the first device to communicate with the second device using a secondary communications technology. The secondary communications module may be a wireless communications module. The secondary communications technology may include one or more of: Wi-Fi technology; near field communications technology; and Bluetooth technology. The instructions, if executed, may further cause the first device to request a cellular service provider to add the second device to the real-time communication.

Examples may include at least an apparatus to facilitate communications, comprising a primary communications module, a sensor, and a secondary communications module. The sensor may detect a motion towards a device while the primary communications module is involved in a real-time communication with one or more parties. The secondary communications module may be a wireless communications module. The secondary communications module may invite the second device to join the real-time communication if the device is authorized to take part in the real-time communication. The sensor may include one or more of: an accelerometer; a global positioning system; a camera; an infrared sensor; and a gyroscope. The primary communications module may include a cellular transceiver. The apparatus may further include an authorization module to determine whether the device is part of a secure circle. The real-time communication may include one or more of: a cellular phone call; an Internet phone call; and an audio stream; and a video stream. The secondary wireless communications module may include one or more of: Wi-Fi technology; near field communications technology; and Bluetooth technology. The apparatus may further include a request module to request a cellular service provider to add the device to the real-time communication.

Examples may include a method to facilitate communications, comprising detecting, by a sensor, a motion on a first device towards a second device while the first device is involved in a real-time communication with one or more parties, and inviting the second device to join the real-time communication if the second device is authorized to take part in the real-time communication. The motion on the first device may be detected by one or more of: an accelerometer; a global positioning system; a camera; an infrared sensor; and a gyroscope. One of a cellular phone, a smart phone, and a tablet may be used to make the motion. One or more of a cellular phone, a smart phone and a tablet may be invited to join the real-time communication. The method may further include determining whether the second device is part of a secure circle. The real-time communication may include one or more of the following: a cellular phone call; an Internet phone call; an audio stream; and a video stream. The method may further include requesting a cellular service provider to add the second device to the real-time communication. The method may further include communicating with the second device using a secondary communications technology. The secondary communications module may be a wireless communications module. The secondary communications technology may include one or more of: Wi-Fi technology; near field communications technology; and Bluetooth technology.

Examples may include at least one non-transitory machine-readable medium comprising one or more instructions which, if executed by a processor, cause a first device to: detect, by a sensor, a motion towards a second device while the first device is involved in a real-time communication with one or more parties; and invite the second device to join the real-time communication if the second device is authorized to take part in the real-time communication. The motion on the first device may be detected by one or more of: an accelerometer; a global positioning system; a camera; an infrared sensor; and a gyroscope. One of a cellular phone, a smart phone, and a tablet may be used to make the motion. One or more of a cellular phone, a smart phone and a tablet may be invited to join the real-time communication. The instructions, if executed, may further cause the first device to determine whether the second device is part of a secure circle. The real-time communication may include at least one of the following: cellular phone call; an Internet phone call; an audio stream; and a video stream. The instructions, if executed, may further cause the first device to request a cellular service provider to add the second device to the real-time communication. The instructions, if executed, may further cause the first device to communicate with the second device using a secondary communications technology. The secondary communications technology may include one or more of: Wi-Fi technology; near field communications technology; and Bluetooth technology.

Examples may include a method to facilitate communications. The method may comprise a means for detect a motion towards from a first device to a second device while the first device is involved in a real-time communication with one or more parties; and a means for inviting the second device to join the real-time communication if the second device is authorized to take part in the real-time communication. The means for detecting a motion may use one or more of: an accelerometer; a global positioning system; a camera; an infrared sensor; and a gyroscope. One of a cellular phone, a smart phone, and a tablet may be used to make the motion. One or more of a cellular phone, a smart phone and a tablet may be invited to join the real-time communication. The method may further include a means for determining whether the second device is part of a secure circle. The real-time communication may include at least one of the following: cellular phone call; an Internet phone call; an audio stream; and a video stream. The method may further include a means for requesting a cellular service provider to add the second device to the real-time communication. The method may further include a means for communicating with the second device using a secondary wireless communications technology. The secondary communications technology may include one or more of: Wi-Fi technology; near field communications technology; and Bluetooth technology.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e., hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, punched cards and paper tapes, optical disks, barcodes, magnetic ink characters and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments may be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus to facilitate communications, comprising:
a primary communications module;
a sensor to detect a motion towards a device while the primary communications module is involved in a real-time communication with one or more parties; and
a secondary communications module to invite the one or more parties to join the real-time communication if the device is authorized to take part in the real-time communication.

2. The apparatus according to claim 1, wherein the sensor includes one or more of: an accelerometer; a global positioning system; a camera; an infrared sensor; or a gyroscope.

3. The apparatus according to claim 1, wherein the primary communications module includes a cellular transceiver.

4. The apparatus according to claim 1, further including an authorization module to determine whether the device is part of a secure circle.

5. The apparatus according to claim 1, wherein the real-time communication includes one or more of: a cellular phone call; an Internet phone call; and an audio stream; or a video stream.

6. The apparatus according to claim 1, wherein the secondary communications module one or more of: Wi-Fi technology; near field communications technology; or
Bluetooth technology.

7. The apparatus according to claim 1, further including a request module to request a cellular service provider to add the device to the real-time communication.

8. A method to facilitate communications, comprising:
detecting, by a sensor, a motion on a first device towards a second device while the first device is involved in a real-time communication with one or more parties; and
inviting the second device to join the real-time communication if the second device is authorized to take part in the real-time communication.

9. The method according to claim 8, wherein the motion on the first device is detected by one or more of: an accelerometer; a global positioning system; a camera; an infrared sensor; or a gyroscope.

10. The method according to claim 8, wherein one of a cellular phone, a smart phone, or a tablet is used to make the motion.

11. The method according to claim 8, wherein one or more of a cellular phone, a smart phone or a tablet is invited to join the real-time communication.

12. The method according to claim 8, further including determining whether the second device is part of a secure circle.

13. The method according to claim 8, wherein the real-time communication includes one or more of the following: a cellular phone call; an Internet phone call; an audio stream; or a video stream.

14. The method according to claim 8, further including communicating with the second device using a secondary wireless communications technology.

15. The method according to claim 14, wherein the secondary wireless communications technology includes one or more of: Wi-Fi technology; near field communications technology; or Bluetooth technology.

16. The method according to claim 8, further including requesting a cellular service provider to add the second device to the real-time communication.

17. At least one non-transitory machine-readable medium comprising one or more instructions which, if executed by a processor, cause a first device to:
detect, by a sensor, a motion towards a second device while the first device is involved in a real-time communication with one or more parties; and
invite the second device to join the real-time communication if the second device is authorized to take part in the real-time communication.

18. The at least one medium according to claim 17, wherein the motion on the first device is detected by one or more of: an accelerometer; a global positioning system; a camera; an infrared sensor; or a gyroscope.

19. The at least one medium according to claim 17, wherein one of a cellular phone, a smart phone, or a tablet is used to make the motion.

20. The at least one medium according to claim 17, wherein one or more of a cellular phone, a smart phone or a tablet is invited to join the real-time communication.

21. The at least one medium according to claim 17, wherein the instructions, if executed, further cause the first device to determine whether the second device is part of a secure circle.

22. The at least one medium according to claim 17, wherein the real-time communication includes at least one of the following: cellular phone call; an Internet phone call; an audio stream; or a video stream.

23. The at least one medium according to claim 17, wherein the instructions, if executed, further causes the first device to communicate with the second device using a secondary wireless communications technology.

24. The at least one medium according to claim 23, wherein the secondary wireless communications technology includes one or more of: Wi-Fi technology; near field communications technology; or Bluetooth technology.

25. The at least one medium according to claim 17, wherein the instructions, if executed, further cause the first device to request a cellular service provider to add the second device to the real-time communication.
